(19) United States
(12) Patent Application Publication
(10) Pub. No.: US 2023/0183584 A1
(43) Pub. Date: Jun. 15, 2023

(54) PROCESS FOR NAPHTHA AROMATIZATION USING A MULTI-STAGE FLUIDIZED SYSTEM

(71) Applicant: UOP LLC, Des Plaines, IL (US)

(72) Inventors: Yili Shi, Buffalo Grove, IL (US); Kurt M. Vanden Bussche, Phoenix, AZ (US); Gavin P. Towler, Inverness, IL (US); John J. Senetar, Naperville, IL (US); Avram M. Buchbinder, Skokie, IL (US); Bryan J. Egolf, Crystal Lake, IL (US); Zhanyong Li, Mount Prospect, IL (US); Elie J. Fayad, Munster, IN (US)

(21) Appl. No.: 17/819,461

(22) Filed: Aug. 12, 2022

Related U.S. Application Data
(60) Provisional application No. 63/289,541, filed on Dec. 14, 2021.

(51) Int. Cl. C10G 35/14; C10G 35/085

(52) U.S. Cl. CPC C10G 35/14; C10G 35/085; C10G 2300/4006; C10G 2400/30

(57) ABSTRACT

A fluidized reforming process comprising a two stage fluidized reforming reactor is described. A naphtha stream flows upward through the two fluidized stages and contacts the catalyst forming a product stream and spent catalyst. The spent catalyst is separated from the product stream and the naphtha feed stream. Some of the spent catalyst is regenerated by contact with an oxygen-containing regeneration fluid to heat and reactivate the catalyst. The heated, regenerated catalyst forms at least a port of the catalyst stream for the process. A process for cyclizing paraffins or isomerizing cyclopentanes is also described. The process uses a chloride-free Pt/Ga-containing catalyst to form a cyclic aliphatic hydrocarbon or isomerizing a cyclopentane in the presence of the chloride-free Pt/Ga-containing catalyst to form a cyclohexane.

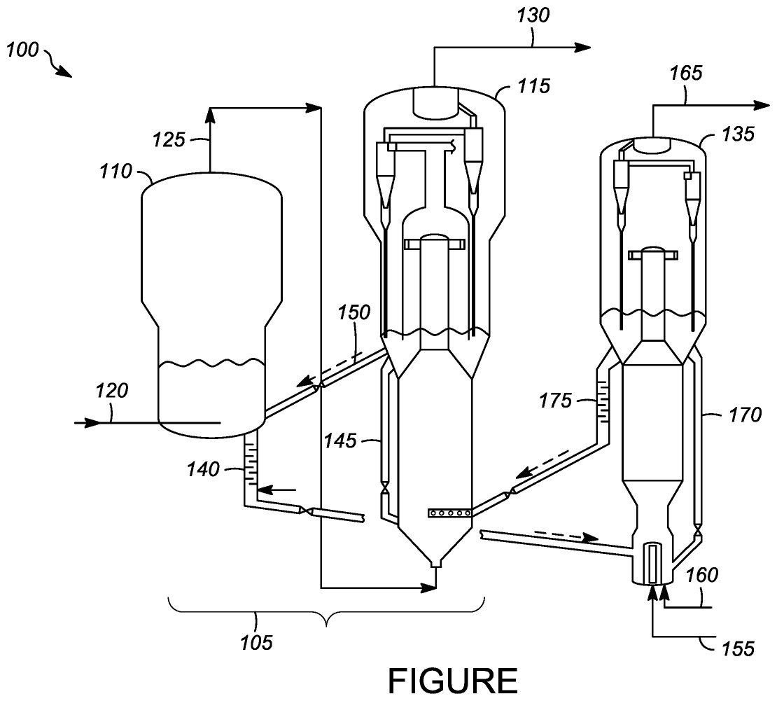

### RELATED APPLICATIONS

This application claims priority to U.S. Provisional Patent Application Ser. No. 63/289,541, filed on Dec. 14, 2021, the entirety of which is incorporated herein by reference.

### BACKGROUND

One well-known hydrocarbon conversion process is catalytic reforming. Generally, catalytic reforming is a well-established hydrocarbon conversion process employed in the petroleum refining industry for improving the octane quality of hydrocarbon feedstocks. The primary products of reforming are a motor gasoline blending component or aromatics for petrochemicals. Reforming may be defined as the total effect produced by dehydrogenation of cyclohexanes and dehydroisomerization of alkylcyclopentanes to yield aromatics, dehydrogenation of paraffins to yield olefins, dehydrocyclization of paraffins and olefins to yield aromatics, isomerization of n-paraffins, isomerization of alkylcycloparaffins to yield cyclohexanes, isomerization of substituted aromatics, and hydrocracking of paraffins. A reforming feedstock can be a hydrocracker, straight run, FCC, or coker naphtha, and it can contain many other components such as a condensate or thermal cracked naphtha.

With catalytic reforming, the most important factor in improving the octane of naphtha is aromatics formation. However, aromatic formation is also the most important contributor to naphtha volume loss. In addition, the aromatics content of gasoline is controlled by environmental regulations, such as the EURO V specification, which can be particularly difficult to meet.

The conventional design philosophy of catalytic reforming involves four to five stages of adiabatic reactors, and a chemistry regime where paraffins and naphthenes are highly equilibrated. Historically, catalytic reforming has improved yield through pressure reductions. Modern targets of less than 40 psig are 10 times lower than the 400 psig target of the 1950's. However, lower pressures typically result in larger equipment, and modern facilities often utilize parallel equipment due to fabrication limits.

Therefore, there is a need for improved, low pressure reforming processes.

### BRIEF DESCRIPTION OF THE DRAWING

The FIGURE is an illustration of one embodiment of a reforming process according to the present invention.

### DESCRIPTION OF THE INVENTION

The present invention meets this need by providing a two stage fluidized reforming reactor. A naphtha stream flows upward through the two fluidized stages and contacts the catalyst forming a product stream and spent catalyst. The spent catalyst is separated from the product stream and the naphtha feed stream. Some of the spent catalyst is regenerated by contact with an oxygen-containing regeneration fluid to heat and reactivate the catalyst. The heated, regenerated catalyst forms at least a port of the catalyst stream for the process.

The two-stage fluidized reactor enables lower average operating pressures, lower recycle gas requirements, and higher paraffin-stage weight-averaged bed temperature (WABT) for enhance selectivity during paraffin cyclization, and it minimizes non-catalytic hot volume requirements associated with thermal cracking. These features combine to increase the range of design throughput and yield for a given capital cost. Specifically with respect to motor fuels, the process can enable higher reactor outlet temperatures amenable to shifting octanes blending from aromatics towards olefin contributions to the gasoline pool.

The two-stage fluidized reactor also leverages the lower WABT demand of naphthene conversion to reduce overall catalyst circulation and orients the regenerated catalyst return such that moisture ingress is isolated to less sensitive regions of the process chemistry.

The circulation is significantly faster than a conventional process which helps separate the process design from coke influences on the catalyst, while lower Pt content and higher reactor temperatures avoid chloride use during reaction and regeneration.

Catalytic reforming generally is applied to a feedstock rich in paraffinic and naphthenic hydrocarbons and is effected through diverse reactions, e.g., dehydrogenation of naphthenes to aromatics, dehydrocyclization of paraffins, isomerization of paraffins and naphthenes, dealkylation of alkylaromatics, hydrocracking of paraffins to light hydrocarbons, and formation of coke which is deposited on the catalyst. Considerable leverage exists for increasing desired product yields from catalytic reforming by promoting the dehydrocyclization reaction over the competing hydrocracking reaction while minimizing the formation of coke.

The hydrocarbon feedstock to the present reforming process comprises paraffins and naphthenes, and may comprise aromatics and small amounts of olefins, preferably boiling within the gasoline range. Feedstocks which may be utilized include straight-run naphthas, natural gasoline, synthetic naphthas, thermal gasoline, catalytically cracked gasoline, partially reformed naphthas or raffinates from extraction of aromatics. Paraffins typically comprise 40-99 mass %, naphthenes 1-60 mass-%, and aromatics 0-50 mass-% of the hydrocarbon feedstock; the olefin content is usually less than about 3 mass-% unless the feedstock comprises a thermally or catalytically cracked component. The distillation range may be that of a full-range naphtha, having an initial boiling point typically from about 40° to 100° C. and a final boiling point of from about 160° to 210° C., or it may represent a narrower-range naphtha having a higher initial and/or lower final boiling point. When the product objective is aromatics for chemical uses, for example, the initial boiling point usually is within the range of about 50°−80° C. and the final boiling point in the range of about 110°−160° C. Both the first and second stages are fluidized bed reactors. Either stage could be a bubbling bed reactor, a fast fluidized bed reactor, or a riser reactor.

Typical reaction conditions for the first stage include one or more of: a temperature in in the range of 400° C. to 600° C., or 450° C. to 500° C.; a pressure of 5-130 psig, or 5-50 psig.

Typical reaction conditions for the second stage include one of more of: a temperature in a range of 525° C. to 600° C.; a superficial velocity in a range of 9.8 m/sec to 26.2 m/sec; a pressure of 5-130 psig, or 5-50 psig.

The superficial velocity within the two stage reactor is typically in the range of 0.5 m/sec to 20 m/sec. The superficial velocity in a bubbling reactor is typically in the range of 0.5 m/sec to 1.2 m/sec, the superficial velocity in a fast fluidized bed reactor is typically in the range of 1.5 m/sec to 2.1 m/sec, and the superficial velocity in a riser reactor is typically in the range of 9.1 m/sec to 20 m/sec. In some embodiments, the superficial velocity in the first stage is 0.5 m/sec to 1.2 m/sec, and the superficial velocity in the second stage is 1.5 m/sec to 2.1 m/sec.

In fluidized bed processes such as this invention, catalyst is circulated continuously from the reactor (in this case a two stage fluidized reactor) to a regenerator and back to the reactor. Catalyst is fluidized in both the reactor and the regenerator with a fluidization gas, which may comprise the hydrocarbon reactant, the hydrocarbon product, hydrogen, nitrogen or other fluidization gases in the reactor. In the regenerator, the fluidization gas may comprise air, oxygen, nitrogen, a fuel, or other fluidization gases. Generally, the residence time of catalyst particles in the reactor and the regenerator is non-uniform and can be described by a distribution of residence times. For definition purposes herein, the residence time distributions of catalyst particles in the reactor are defined on a catalyst weight basis. The average residence time of particles is defined as the mean time spent in the reactor of a weight-distribution of catalyst particles. The distribution of catalyst particles in the reactor can have different characteristics. Different fluidized bed processes have different distributions of catalyst residence times, ranging from plug flow to continuous back-mixed reactors with similar residence time distribution to a continuous stirred tank reactor (CSTR). A preferred embodiment is a fast-fluidized bed with residence time distribution similar to a continuous back-mixed reactor. Since the catalyst deactivates quickly under reaction conditions, shorter catalyst residence times allow for higher average catalyst activity since more of the catalyst is on stream at earlier times and is thus more active. The catalyst in this invention deactivates quickly, but sufficient activity is captured if the residence time is short. However, shorter residence times also necessitate faster catalyst circulation rates which over time will lead to more catalyst attrition and require utility costs for circulating catalyst. In some embodiments, the total average catalyst residence time in the two stage fluidized reactor is from 30 seconds to 5 minutes, or from 1 minute to 2.5 minutes. The average residence time of a hydrocarbon in the two stage fluidized reactor in a range of 0.1 to 30 sec, or 0.5 to 10 sec. In some embodiments, 10% to 90% of the average residence time of the hydrocarbon is in the first stage.

The catalyst to hydrocarbon weight ratio within the two stage fluidized reactor is in a range of 2:1 to 100:1, or 5:1 to 30:1.

Depending on the type of fluidized beds used, the temperature in the second stage may be greater than the temperature in the first stage.

Depending on the type of fluidized beds used, the superficial velocity in the second stage may be greater than the temperature in the first stage.

In some embodiments, a portion of the heated regenerated catalyst is introduced into the second stage. In some embodiments, a second portion of the catalyst is introduced into the first stage.

In some embodiments, the first reaction stage utilizes a lower temperature and content time to favor naphthene dehydrogenation, while the second stage utilizes a higher WABT to favor paraffin dehydrocyclization. Due to the significantly higher catalyst circulation, the process can be operated at lower H2:HC ratio and lower pressure without hinderance from bed endotherm and coke laydown.

A portion of the catalyst from the first stage is sent to the regenerator where it is contacted with an oxygen-containing regeneration fluid and heated and reactivated.

In the second stage, the catalyst is separated from the naphtha feed and the reaction products. The product stream comprising reaction products and the naphtha feed is removed and sent for further processing to recover the reaction products.

A portion of the separated catalyst is recirculated to the bottom of the second stage. Another portion of the separated catalyst is sent to the first stage. Alternatively, or additionally, a portion of the separated catalyst can be sent directly to the regenerator for regeneration.

The heated regenerated catalyst can be returned to the second stage, the first stage, or both. In accordance with an embodiment of the present disclosure, a catalytic composite is disclosed. The catalytic composite may comprise a first component selected from Group VIII noble metal components and combinations thereof, a second component selected from one or more of alkali and alkaline earth metal components, and a third component selected from one or more of tin, germanium, lead, indium, gallium, and thallium. The first component, the second component, and the third component are all supported on an alumina support.

The first component is well dispersed throughout the catalytic composite. The catalytic composite may comprise the first component in an amount from about 0.005 weight percent to about 5.0 weight percent, or from about 0.005 weight percent to about 1.0 weight percent, or from about 0.005 weight percent to about 0.8 weight percent, calculated on an elemental basis of the final catalytic composite. In an exemplary embodiment, the Group VIII noble metal may be selected from platinum, palladium, iridium, rhodium, osmium, ruthenium, or combinations thereof.

The first component, selected from the Group VIII noble metal components and combinations thereof, may be incorporated in the catalytic composite in any suitable manner such as, for example, by coprecipitation or cogellation, ion exchange or impregnation, or deposition from a vapor phase or from an atomic source or by like procedures either before, while, or after other catalytic components are incorporated. In an exemplary embodiment, the first component may be incorporated in the catalytic composite by impregnating the alumina support with a solution or a suspension of a decomposable compound of the first component. For example, platinum may be added to the support by commingling the latter with an aqueous solution of chloroplatinic acid. Another acid, for example, nitric acid or other optional components, may be added to the impregnating solution to further assist in evenly dispersing or fixing the first component in the catalytic composite.

The second component of the catalytic composite may be selected from one or more of alkali and alkaline earth metal components (Groups I and II of the Periodic Table). The second component may also be selected from either or both of these groups. Suitable metals of Groups I and II of the Periodic Table include, but are not limited to, Na, K, Cs, Mg, Sr, Ba, and Ca. It is believed that the alkali and the alkaline earth component exists in the final catalytic composite in an oxidation state above that of the elemental metal. The alkali and alkaline earth component may be present as a compound such as oxide, for example, or combined with the support or with the other catalytic components.

The second component may also be well dispersed throughout the catalytic composite. The catalytic composite may comprise the second component in an in an amount from about 0.005 weight percent to about 5.0 weight percent, or from about 0.005 weight percent to about 2.0 weight percent, or from about 0.005 weight percent to about 1.5 weight percent, calculated on an elemental basis of the final catalytic composite.

The second component, selected from one or more of the alkali or alkaline earth metal components or mixtures thereof, may be incorporated in the catalytic composite in any suitable manner such as, for example, by coprecipitation or cogellation, by ion exchange or impregnation, or by like procedures either before, while, or after other catalytic components are incorporated. In an exemplary embodiment, the second component may be incorporated in the catalytic composite by impregnating the support with a solution of potassium hydroxide. In another exemplary embodiment, the second component may be incorporated in the catalytic composite by impregnating the support with a solution of potassium chloride.

The third component of the catalytic composite is a modifier metal component selected from tin, germanium, lead, indium, gallium, thallium, or mixtures thereof. The third component may be incorporated in the catalytic composite in any suitable manner. In an exemplary embodiment, the third component may be incorporated in the catalytic composite by impregnation.

The modifier metal component may be uniformly dispersed throughout the catalytic composite. This uniform dispersion can be achieved in a number of ways including impregnation of the catalyst with a modifier metal component containing solution, and incorporating the modifier metal component into the catalyst during catalyst support formulation. In the latter method, the modifier metal component may be added to the refractory oxide support during its preparation. In the case where the catalyst is formulated from a solution of the desired refractory oxide or precursor, the modifier metal may be incorporated into the solution before the catalyst was shaped. If the catalyst was formulated from a powder of the desired refractory oxide or precursor, the modifier may be added again prior to the shaping of the catalyst in the form of a dough into a particle. Incorporating the modifier metal into the catalyst support during its preparation may uniformly distribute the modifier metal throughout the catalyst.

The third component may be incorporated in the catalytic composite in any suitable manner such as by coprecipitation or cogellation with the carrier material, ion-exchange with the carrier material or impregnation of the carrier material at any stage in the preparation.

The catalytic composite may comprise the third component in an amount from about 0.01 weight percent to about 5.0 weight percent, or from about 0.05 weight percent to about 4.0 weight percent, or from about 0.1 weight percent to about 3.0 weight percent, calculated on an elemental basis of the final catalytic composite.

The third component may exist within the catalytic composite as a compound such as oxide, sulfide, halide, oxychloride, aluminate, etc., or in combination with the support or other ingredients/components of the catalytic composite. The third component of the catalyst may be composited with the support in any sequence. Thus, the first or the second component may be impregnated on the support followed by sequential surface or uniform impregnation of the third component. Alternatively, the third component may be surface impregnated or uniformly impregnated on the support followed by impregnation of the other catalytic component.

The catalytic composite may also comprise a halogen component. The halogen component may be fluorine, chlorine, bromine, or iodine, or mixtures thereof. In an exemplary embodiment, chlorine may be used as the halogen component. The halogen component may be present in a combined state with the porous support and the alkali component. The halogen component may also be well dispersed throughout the catalytic composite. The halogen component may be present in an amount from more than 0.01 weight percent to about 6 weight percent, or 0.01 weight percent to 4 weight percent, or 0.01 weight percent to 2 weight percent, or 0.01 weight percent to 1 weight percent, calculated on an elemental basis, of the final catalytic composite. The inclusion of a halogen in the catalyst results in an increased rate of reaction.

The halogen component may be incorporated in the catalytic composite in any suitable manner, either during the preparation of the support or before, while, or after other catalytic components are incorporated. For example, the alumina solution that may be utilized to form the aluminum support may contain halogen and thus contribute at least some portion of the halogen content in the final catalytic composite. The halogen component or a portion thereof may be added to the catalytic composite during the incorporation of the support with other catalyst components, for example, by using chloroplatinic acid to impregnate the platinum component. The halogen component or a portion thereof may be added to the catalytic composite by contacting the catalyst with the halogen or a compound or a solution containing the halogen before or after other catalyst components are incorporated with the support. The halogen component or a portion thereof may be added during the heat treatment of the catalytic composite. Suitable compounds containing the halogen include acids containing the halogen, for example, hydrochloric acid. The halogen component or a portion thereof may be incorporated by contacting the catalytic composite with a compound or a solution containing the halogen in a subsequent catalyst regeneration step. In the regeneration step, carbon deposited on the catalyst as coke during use of the catalyst in a hydrocarbon conversion process is burned off and the catalyst and the platinum group component on the catalyst is redistributed to provide a regenerated catalyst with performance characteristics much like the fresh catalyst. The halogen component may be added during the carbon burn step or during the Group VIII noble metal component redispersion step, for example, by contacting the catalyst with a chlorine gas. Also, the halogen component may be added to the catalytic composite by adding the halogen or a compound or solution containing the halogen, such as propylene dichloride, for example, to the hydrocarbon feed stream or to the recycle gas during operation of the hydrocarbon conversion process. The halogen may also be added as chlorine gas (Cl2).

The support of the catalytic composite is typically an alumina support. The support may be prepared by any suitable manner from synthetic or naturally occurring raw materials. Also, the support may be formed in any desired shape such as spheres, pills, cakes, extrudates, powders, granules, and other shapes, and it may be utilized in any particle size. In an exemplary embodiment, the shape of support is spherical. A particle size of about ⅛ inch (3 mm) in diameter or about 1/16 inch (1.6 mm) in diameter may be used. A larger particle size may also be utilized.

In some embodiments, the catalyst typically comprises 50 to 750 ppmw Pt; 0.5 to 3.0 wt % Ga; 0.025 to 0.6 wt % Sn; and 50 to 1000 ppmw metal ions of Groups I and II of the Periodic Table.

In some embodiments, the catalyst has low level of Pt, about 200 ppmw, which is about 10 times less than a typical CCR reforming catalyst. In some embodiments, the catalyst has about 1.5% wt of Ga, 400 ppmw of K, and 0.3% wt of Sn. The catalyst may need to be replenished more often than the oil-dropped spherical (ODS) catalysts used in the CCR reforming process due to catalyst attrition.

In some embodiments, the catalyst is halogen-free. “Halogen-free” or “chloride-free” means that no halogen or chloride is intentionally injected. By eliminating the presence of halogens, such as chloride, the need for chloride management systems in the process is eliminated.

The low pressure, low hydrogen/hydrocarbon ratio, and high temperature operation in the fluidized bed configuration favors the formation of olefinic products, which is valuable for increasing RONC.

Another aspect of the invention is a process for cyclizing paraffins or isomerizing cyclopentanes. The process comprises cyclizing a paraffin having 6 to 13 carbon atoms, or 7 to 10 carbon atoms, in the presence of a chloride-free Pt/Ga-containing catalyst to form a cyclic aliphatic hydrocarbon or isomerizing a cyclopentane in the presence of the chloride-free Pt/Ga-containing catalyst to form a cyclohexane. The chloride-free Pt/Ga-containing catalyst comprises: 50 to 750 ppmw Pt; 0.5 to 3.0 wt % Ga; 0.025 to −0.6 wt % Sn; and 50 to 50 to 1000 ppmw metal ions of Groups I and II of the Periodic Table.

The FIGURE illustrates one embodiments of the process. 100. The two stage fluidized reactor 105 comprises a first fluidized stage 110 and a second fluidized stage 115. The naphtha feed stream 120 comprising naphtha is sent to the first fluidized stage 110 where it is contacted with the catalyst. The first stage product stream 125 comprising naphtha and a hydrogen-rich carrier gas is sent to the second fluidized stage 115 where it is further contacted with catalyst. Optimally, the reforming is effected in the substantial absence of added hydrogen, with a molar ratio of hydrogen to naphtha feedstock of no more than about 0.3. However, larger ratios of hydrogen-to-naphtha may be required based on heat recovery equipment design options. Naphthene dehydrogenation is the most reactive within reforming chemistry, followed by longer-chain paraffin cyclization.

The catalyst in the second fluidized stage 115 is separated from the second stage product. The second stage product stream 130 is sent to a product recovery section (not shown). Separation of the reactor effluent in product-recovery zone may be according to any means known in the art, preferably comprising separation of a hydrogen-rich gas at near-ambient temperature and stripping in a fractionator to separate light hydrocarbons from the aromatized product. Using techniques and equipment known in the art, the filtered reactor-effluent vapors preferably are passed through a cooling zone to a separation zone. In the separation zone, typically maintained at about 0° to 65° C., a hydrogen-rich gas is separated from a liquid phase. The resultant hydrogen-containing stream can then be recycled through suitable compressing means back to the fluidized reactor, but usually the entire stream is directed to other refinery hydrogen uses or to fuel. The liquid phase from the separation zone is normally withdrawn and processed in a fractionating system in order to adjust the concentration of light hydrocarbons and produce an aromatics-rich saturated product.

The light hydrocarbons separated from the aromatics-rich product comprise propane and usually butanes if the product is to be blended into gasoline, and may comprise pentanes if the product is to be further processed to recover aromatic hydrocarbons. The reforming process produces an aromatized product stream containing relatively small amounts of olefins, usually less than about 10 mass-% and more usually less than about 5 mass-% of the C5+ (pentanes and heavier hydrocarbons) product. The aromatics content typically is within the range of about 60 to 99 mass %, usually at least about 80 mass-%, and more usually about 90 mass-% or more, of the C5+ aromatized product. The composition of the aromatics will depend principally on the feedstock composition and operating conditions, and generally will consist principally of aromatics within the C6-C12 range. Benzene, toluene and C8 aromatics are preferred components of the aromatics portion of the product.

In some cases, a portion of the catalyst from the first fluidized stage 110 is sent to a regenerator 135 through line 140. A portion of the catalyst in the second fluidized stage 115 can be recycled to the bottom of the second fluidized stage 115 through line 145. Another portion of the catalyst in the second fluidized stage 115 can be sent to the first fluidized stage 110 through line 150. Alternatively, or additionally, a portion of the catalyst from the second fluidized stage 115 can be sent directly to the regenerator 135 (not shown).

Fuel stream 155 is provided to the regenerator 135, and the catalyst in the regenerator 135 is contacted with an oxygen-containing gas 160 and reactivated. The regenerated catalyst is separated from the flue gas. The flue gas 165 may be sent for treatment (not shown).

Some of the regenerated catalyst is recycled to the bottom of the regenerator 135 through line 170. Another portion of the regenerated catalyst is returned to the second fluidized stage 115 through line 175.

The following examples are presented to demonstrate the invention and to illustrate certain specific embodiments thereof, and should not be construed to limit the scope of the invention as set forth in the claims. There are many possible other variations, as the skilled routineer will recognize, which are within the spirit of the invention.

### EXAMPLES

### Example 1

The catalysts were tested in a simulated fluidized pilot plant. The loaded mass and composition of catalysts are provided below in Table 1. High-platinum Catalyst A was reduced under 50% H2/He at 550° C. for 1-hr prior to testing. The low-platinum Catalysts B and C were activated at 550° C. for 30 minutes under air, after which they were purged with He for 5 minutes which was changed to 50% H2 in He for 20 seconds of reduction. A 1-μL feed of hydrocracked naphtha (67% N+2A (naphtha plus twice aromatic) content, with a boiling point range of 192-382° F. by ASTM-D86) was then vaporized and injected for conversion by the catalyst. The reactor outlet was directly connected to a GC inlet for product characterization.

Table 1 shows the material balance for a range of catalyst examples. The comparison of Catalysts A and B illustrates that similar yields are attainable within the configuration at a much lower content of halogen and platinum. Catalyst C incorporates gallium and potassium, yielding higher amounts of C5+ non-aromatics and liquified petroleum gas (LPG).

### Example 2

A process similar to Example 1 was run with the following changes. The catalyst had an additional pretreatment step to provide moisture stabilization for the catalyst by injecting a 0.8-μL pulse of water during the last 10-seconds of the catalyst reduction. Two different feeds were tested: cis-1,3-dimethylcyclopentane in one case, and a blend of 53 mass % n-heptane and 47 mass % o-xylene in the other. The performance across these feeds provides an example of catalyst performance within the first and second stages.

Table 2 illustrates the impact of catalyst composition from moisture. Although the activity of Catalyst C was impacted by moisture, the altered formulation improves the resilience of selectivity against moisture, particularly within the second reaction stage. During this testing, Catalysts B and C provided similar selectivity to Catalyst A across the dimethylcyclopentane feed, while the selectivity ranking across the n-heptane/o-xylene feed reflected the observations in Table 1.

TABLE 1

| | | | | | | | | Yield, % w | | | | |
|---|---|---|---|---|---|---|---|---|---|---|---|---|
| | Pt | Sn | Cl | Ga | K | Temperature | Loading | | | C₅₊ non- | | |
| | (ppmw) | (wt %) | (wt %) | (wt %) | (ppmw) | (degC.) | (mg) | Aromatics | H₂ | aromatics | C₂-C₄ | C₁ |
| Catalyst A | 2500 | 0.3 | 1% | — | — | 560 | 16.3 | 84.34 | 4.61 | 6.66 | 3.73 | 0.65 |
| Catalyst B | 200 | 0.3 | 0% | — | — | 560 | 120.9 | 84.98 | 4.60 | 5.97 | 3.86 | 0.59 |
| Catalyst C | 200 | 0.3 | 0% | 1.5 | 400 | 540 | 119.8 | 81.72 | 4.53 | 6.78 | 6.50 | 0.46 |

TABLE 2

| | | | Conversion |
|---|---|---|---|
| | Aromatics Selectivity Change | | Change |
| | Catalyst | Catalyst | Catalyst |
| | B | C | C |
| DMCP feed @ 500 C. | −22.5% | −8.1% | −49.5% |
| nC7/oX feed @ 560 C. | −8.4% | +7.1% | −16.5% |

### Specific Embodiments

While the following is described in conjunction with specific embodiments, it will be understood that this description is intended to illustrate and not limit the scope of the preceding description and the appended claims.

A first embodiment of the invention is a process comprising providing a two stage fluidized reactor comprising a first fluidized stage and a second fluidized stage; introducing a naphtha feed stream comprising naphtha into the first stage, the naphtha feed stream flowing upward through the first stage and the second stage and contacting a catalyst in the first stage and the second stage, reforming the naphtha feed stream and forming a product stream and spent catalyst, the first stage at first reforming conditions and the second stage at second reforming conditions; separating the spent catalyst from the naphtha feed stream and the product stream; transferring at least a portion of the spent catalyst to a regenerator where the spent catalyst is contacted with an oxygen-containing regeneration fluid, the spent catalyst being heated and reactivated to obtain a heated regenerated catalyst, wherein at least a portion of the catalyst stream comprises the heated regenerated catalyst. An embodiment of the invention is one, any or all of prior embodiments in this paragraph up through the first embodiment in this paragraph wherein the first stage comprises a bubbling bed reactor, a fast fluidized bed reactor, or a riser reactor, and wherein the second stage comprises a bubbling bed reactor, a fast fluidized bed reactor, or a riser reactor. An embodiment of the invention is one, any or all of prior embodiments in this paragraph up through the first embodiment in this paragraph wherein a temperature in the second stage is greater than a temperature in the first stage. An embodiment of the invention is one, any or all of prior embodiments in this paragraph up through the first embodiment in this paragraph wherein a superficial velocity in the second stage is greater than a superficial velocity in the first stage. An embodiment of the invention is one, any or all of prior embodiments in this paragraph up through the first embodiment in this paragraph wherein the first stage comprises a bubbling bed reactor and wherein the second stage comprises a fast fluidized bed reactor. An embodiment of the invention is one, any or all of prior embodiments in this paragraph up through the first embodiment in this paragraph wherein a first portion of the heated regenerated catalyst is introduced into the second stage. An embodiment of the invention is one, any or all of prior embodiments in this paragraph up through the first embodiment in this paragraph wherein a second portion of the heated regenerated catalyst is introduced into the first stage. An embodiment of the invention is one, any or all of prior embodiments in this paragraph up through the first embodiment in this paragraph wherein a flow of the catalyst in the first and second stage is countercurrent to the naphtha feed stream, or wherein a flow of the catalyst in the first and second stage is co-current to the naphtha feed stream. An embodiment of the invention is one, any or all of prior embodiments in this paragraph up through the first embodiment in this paragraph further comprising passing at least a first portion of the separated spent catalyst to the first stage before transferring the at least the portion of the spent catalyst to the regenerator. An embodiment of the invention is one, any or all of prior embodiments in this paragraph up through the first embodiment in this paragraph further comprising passing at least a portion of the separated spent catalyst to the second stage. An embodiment of the invention is one, any or all of prior embodiments in this paragraph up through the first embodiment in this paragraph wherein the catalyst comprises 50 to 750 ppmw Pt; 0.5 to 3.0 wt % Ga; 0.025 to 0.6 wt % Sn; 50 to 1000 ppmw metal ions of Groups I and II of the Periodic Table. An embodiment of the invention is one, any or all of prior embodiments in this paragraph up through the first embodiment in this paragraph wherein the catalyst is halogen-free. An embodiment of the invention is one, any or all of prior embodiments in this paragraph up through the first embodiment in this paragraph wherein the first reforming conditions comprise one or more of a temperature in a range of 400° C. to 600° C.; of a pressure in a range of 5 to 130 psig. An embodiment of the invention is one, any or all of prior embodiments in this paragraph up through the first embodiment in this paragraph wherein the second reforming conditions comprise one or more of a temperature in a range of 525° C. to 600° C.; or a pressure in a range of 5 to 130 psig. An embodiment of the invention is one, any or all of prior embodiments in this paragraph up through the first embodiment in this paragraph wherein one or more of an average residence time of the catalyst in the two stage fluidized reactor is in a range of 30 sec to 5 min; an average residence time of a hydrocarbon in the two stage fluidized reactor is in a range of 0.1 to 30 sec; a superficial velocity within the two stage fluidized reactor is in a range of 1 m/sec to 10 m/sec; or catalyst to hydrocarbon weight ratio within the two stage fluidized reactor is in a range of 21 to 1001. An embodiment of the invention is one, any or all of prior embodiments in this paragraph up through the first embodiment in this paragraph wherein 10% to 90% of the hydrocarbon average residence time is in the first stage.

A second embodiment of the invention is a process for cyclizing paraffins or isomerizing cyclopentanes comprising cyclizing a paraffin having 6 to 13 carbon atoms in the presence of a halogen-free Pt/Ga-containing catalyst to form a cyclic aliphatic hydrocarbon or isomerizing a cyclopentane in the presence of the chloride-free Pt/Ga-containing catalyst to form a cyclohexane. An embodiment of the invention is one, any or all of prior embodiments in this paragraph up through the second embodiment in this paragraph wherein the chloride-free Pt/Ga-containing catalyst comprises 50 to 750 ppmw Pt; 0.5 to 3.0 wt % Ga; 0.025 to 0.6 wt % Sn; 50 to 1000 ppmw metal ions of Groups I and II of the Periodic Table.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A fluidized reforming process comprising:
providing a two stage fluidized reactor comprising a first fluidized stage and a second fluidized stage;
introducing a naphtha feed stream comprising naphtha into the first stage, the naphtha feed stream flowing upward through the first stage and the second stage and contacting a catalyst in the first stage and the second stage, reforming the naphtha feed stream and forming a product stream and spent catalyst, the first stage at first reforming conditions and the second stage at second reforming conditions;
separating the spent catalyst from the naphtha feed stream and the product stream; and
transferring at least a portion of the spent catalyst to a regenerator where the spent catalyst is contacted with an oxygen-containing regeneration fluid, the spent catalyst being heated and reactivated to obtain a heated regenerated catalyst, wherein at least a portion of the catalyst stream comprises the heated regenerated catalyst.

2. The process of claim 1 wherein the first stage comprises a bubbling bed reactor, a fast fluidized bed reactor, or a riser reactor, and wherein the second stage comprises a bubbling bed reactor, a fast fluidized bed reactor, or a riser reactor.

3. The process of claim 1 wherein a temperature in the second stage is greater than a temperature in the first stage.

4. The process of claim 1 wherein a superficial velocity in the second stage is greater than a superficial velocity in the first stage.

5. The process of claim 1 wherein the first stage comprises a bubbling bed reactor and wherein the second stage comprises a fast fluidized bed reactor.

6. The process of claim 1 wherein a first portion of the heated regenerated catalyst is introduced into the second stage.

7. The process of claim 1 wherein a second portion of the heated regenerated catalyst is introduced into the first stage.

8. The process of claim 1 wherein a flow of the catalyst in the first and second stage is countercurrent to the naphtha feed stream, or wherein a flow of the catalyst in the first and second stage is co-current to the naphtha feed stream.

9. The process of claim 1 further comprising:
passing at least a first portion of the separated spent catalyst to the first stage before transferring the at least the portion of the spent catalyst to the regenerator.

10. The process of claim 1 further comprising:
passing at least a portion of the separated spent catalyst to the second stage.

11. The process of claim 1 wherein the catalyst comprises:
50 to 750 ppmw Pt;
0.5 to 3.0 wt % Ga;
0.025 to 0.6 wt % Sn; and
50 to 1000 ppmw metal ions of Groups I and II of the Periodic Table.

12. The process of claim 1 wherein the catalyst is halogen-free.

13. The process of claim 1 wherein the first reforming conditions comprise one or more of:
a temperature in a range of 400° C. to 600° C.; or
a pressure in a range of 5 to 130 psig.

14. The process of claim 1 wherein the second reforming conditions comprise one or more of:
a temperature in a range of 525° C. to 600° C.; or
a pressure in a range of 5 to 130 psig.

15. The process of claim 1 wherein one or more of:
an average residence time of the catalyst in the two stage fluidized reactor is in a range of 30 sec to 5 min;
an average residence time of a hydrocarbon in the two stage fluidized reactor is in a range of 0.1 to 30 sec;
a superficial velocity within the two stage fluidized reactor is in a range of 1 m/sec to 10 m/sec; or
catalyst to hydrocarbon weight ratio within the two stage fluidized reactor is in a range of 2:1 to 100:1.

16. The process of claim 15 wherein 10% to 90% of the hydrocarbon average residence time is in the first stage.

17. A process for cyclizing paraffins or isomerizing cyclopentanes comprising:
cyclizing a paraffin having 6 to 13 carbon atoms in the presence of a halogen-free Pt/Ga-containing catalyst to form a cyclic aliphatic hydrocarbon or isomerizing a cyclopentane in the presence of the chloride-free Pt/Ga-containing catalyst to form a cyclohexane.

18. The process of claim 17 wherein the chloride-free Pt/Ga-containing catalyst comprises:
50 to 750 ppmw Pt;
0.5 to 3.0 wt % Ga;
0.025 to 0.6 wt % Sn; and
50 to 1000 ppmw metal ions of Groups I and II of the Periodic Table.
